(19) United States
(12) Patent Application Publication
(10) Pub. No.: US 2008/0313473 A1
(43) Pub. Date: Dec. 18, 2008

(54) METHOD AND SURVEILLANCE TOOL FOR MANAGING SECURITY OF MASS STORAGE DEVICES

(75) Inventors: Luc Provencher, St-Lin-Laurentides (CA); Olivier Fournier, Blainville (CA); Clement Gosselin, Piedmont (CA); Ann Marie Colizza, Piedmont (CA)

Correspondence Address: BERESKIN AND PARR, 40 KING STREET WEST, BOX 401, TORONTO, ON, M5H 3Y2, CA

(73) Assignee: LES TECHNOLOGIES DELTACRYPT, Piedmont (CA)

(21) Appl. No.: 11/761,635

(22) Filed: Jun. 12, 2007

(51) Int. Cl. G06F 12/14; G06F 12/16; H04L 9/32

(52) U.S. Cl. 713/191; 713/189; 713/193

(57) ABSTRACT

The present invention relates to a method and a surveillance tool for managing security of mass storage devices. The method and surveillance tool installs a surveillance tool on a computer, and verifies whether there is a mass storage device connected to the computer. Then, the method determines whether the mass storage device is secured with an appropriate encryption tool, and if the mass storage device is not secured with the appropriate encryption tool, the method prevents use of the mass storage device and secures the mass storage device.

### FIELD OF THE INVENTION

The present invention relates to mass storage devices, and more particularly to a method and a surveillance tool for managing security of mass storage devices.

### BACKGROUND OF THE INVENTION

Nowadays, computer security has become an important issue. As computers are used to run daily operations, store business and personal confidential information, communicate with others, security has become mandatory to reduce and hopefully avoid industrial piracy.

Many security tools have been developed to increase protection of information stored on computers. For example, firewalls are used to block entrance of threatening mails and attachments, and to prevent intrusion of pirates on computers and on local area networks. Encryption algorithm applications are installed to encrypt hard drives and files contained on a computer and a server.

Some security tools specialize in encrypting content of mass storage devices, such as USB memory sticks, cameras, DVD readers/writers, and many other products, which offer additional mass storage external to a computer. Typically, these security tools consist of software that must be installed on the computer in which the mass storage device is to be inserted in. The installed security tool encrypts directly from the computer the information to be stored on the mass storage device, and stores it on the mass storage device. To access the information on the mass storage device, the latter must then be introduced in a computer that has the security tool installed thereon so as to allow proper decryption of the stored information thereon.

Some other security tools consist of software installed on a mass storage device to protect mobile data combined to software installed on the host computer in order for a mass storage device protection to function when connected to a computer with limited privileges (user account). Without the proper software on the host computer, the protected mass storage device will not function in most industries where computers have no administrator privileges in order to limit viruses' invasions.

Furthermore, some mass storage device security tool offer a secured partition and an unsecured partition leaving it up to the user to put his sensitive files in the right partition on his device.

There are multiple drawbacks with such security tools. When the security tool is installed on the computer, a user must first ensure that the security tool used to encrypt information on the mass storage device is installed on all computers from which he/she desires to access the encrypted information. To complicate matters, security tools are not compatible with one another, thus when the user whishes to use the mass storage device to share information with other people, he/she must ensure that the security tool that was used to encrypt the information on the mass storage device is available and installed on the computer of the people with whom he/she wishes to share the stored information.

Another drawback is not be able to use the protected mass storage device from any computer in most industries since an application needs to be installed on a computer without administrator privileges for the security tool to function.

And finally, most mass storage device security tools come with a secured and an unsecured partition. The responsibility of securing sensitive data relies on the user's decision. Corporate files may be misplaced in the unsecured section of the protected mass storage device or the user may judge that a file is not sensitive while an organization may think otherwise. Not only protection relies on a user's action but it also relies on his judgment.

To overcome these problems, users typically do not encrypt information stored on mass storage devices. Leaving such stored information unprotected causes a serious threat to the security of the stored information.

There is therefore a need to provide a method and a surveillance tool for managing security of mass storage devices. It would also be a further advantage to provide a surveillance tool that allows securing of sensitive files on mass storage devices without relying on any users' decisions. There is also a need for companies to ensure that all mass storage devices used to store company related information are properly protected.

### SUMMARY OF THE INVENTION

In order to overcome the problems encountered in the prior art, the present invention describes a method for managing security of mass storage devices that is practical and simple. In accordance with an aspect of the invention, the method of the present invention allows securing of sensitive files on mass storage devices without relying on any users' decisions.

In accordance with a first aspect, the present invention relates to a method of managing security of a mass storage device. The method includes steps of installing a surveillance tool on a computer and verifying whether there is a mass storage device connected to the computer. The method then pursues with a step of determining whether the mass storage device is secured with an appropriate encryption tool, and preventing use of the mass storage device and optionally securing the latter if not already secured.

In accordance with another aspect, the present invention relates to a surveillance tool for securing a mass storage device. The surveillance tool includes a verification module for verifying whether the mass storage device is connected, and for determining whether an appropriate encryption tool is present on the mass storage device, and a blocking module for blocking access to the mass storage device when the verification module determines that the appropriate encryption tool is not present on the mass storage device.

### BRIEF DESCRIPTION OF THE DRAWINGS

The present invention will be more easily understood with reference to the following Figures, in which like references denote like parts/steps. The following Figures will further be used in connection with the Detailed Description of the Invention to describe aspects of the present invention, in which:

FIG. 1 and Error! Reference source not found. are flowcharts of an exemplary method performed by an appropriate encryption tool in accordance with a first aspect of the present invention;

Error! Reference source not found. is a block diagram of an exemplary appropriate encryption tool in accordance with an aspect of the present invention;

Error! Reference source not found. to Error! Reference source not found. are detailed block diagrams of Error! Reference source not found.;

Error! Reference source not found. is a flowchart of a method of managing security of a mass storage device in accordance with another aspect of the present invention; and

FIG. 13 is a block diagram of an exemplary surveillance tool in accordance with an aspect of the present invention.

### DETAILED DESCRIPTION OF THE INVENTION

The present invention provides a simple and practical method and tool for managing security of mass storage devices.

The expression “mass storage device” is used throughout the present specification and appended claims to refer to any type of mass storage device, which can be connected to a computer. Some examples of mass storage devices include a Compact Disk Writer, a Universal Serial Bus (USB) key, a camera, a Digital Versatile Disc (DVD) writer, an IPod™ an external hard drive, a Firewire™ or any external memory means.

The expression “appropriate encryption tool” refers to an encryption tool that is known, recognized and authorized by the surveillance tool and method of the present invention. An example of such an encryption tool includes the Dusk™ offered by Les Technologies DeltaCrypt.

In the context of the present invention, the expression “computer” includes any type of computer to which the mass storage device may be connected to: personal computer, laptop, Mac™, etc.

Referring to Error! Reference source not found. and Error!Reference source not found., there are shown flowcharts of an exemplary method 100 performed by an appropriate encryption tool. The method starts with an administrator module (steps 103-109), followed by an installing module (steps 110-114). Then, the method continues with a configuration module (steps 115-134) and an open module (steps 135-149). Upon successful opening by the open module, the appropriate encryption tool continues with steps 150-195 shown on FIG. 2.

More particularly, the method starts with installing on a computer from which mass storage devices may be used, of an administrator module. At step 103, an administrator password is entered. As per step 104, a secret key is generated from the administrator password using a symmetric key generator. At the same time, a random value password is generated at step 105. At step 106, from this random value password is created an administrator public-private key pair. At step 107, the private key from the private-public key pair is encrypted using the secret key generated from the administrator password. A symmetric encryption algorithm is used to encrypt the said private key. Step 109 further continues by saving the encrypted private key on the administrator's computer. This private key includes a MAC (Message Authentification Code) like HMAC to ensure its integrity protection and for authentication purposes.

An asymmetric encryption algorithm, such as the Rivest, Shamir, and Adelman (RSA) public-key encryption algorithm is preferably used to generate the administrator public-private key pair. This administrator public key once created is hashed with a hashing algorithm such as SHA-1, SHA-256 or MD5. The administrator public key hash digest is encrypted using the private key from the private-public key pair. The encrypted hash digest is saved at the end of the public key file, which is distributed at step 109 to the user before installing the appropriate encryption tool on his mass storage device. The hashing function is used to ensure that the public key file integrity has not been compromised.

The integrity verification is accomplished by comparing two hash digests when the administrator public key is used to open the invention. The first hash digest comes from the encrypted administrator public key hash digest (found at the end of the public key file) that is decrypted using the administrator public key. The second hash digest is obtained through hashing the administrator public key using the same hashing algorithm as the one used for the encrypted administrator public key digest. If the integrity of the administrator public key has not been compromised, the resulting hash digests will be identical. If these hash digests are not identical, it indicates that the administrator public key has been altered.

Once integrated, the administrator public key is used as a master key to recuperate a user's data on the mass storage device if the user forgets his opening password.

The method then continues at step 110 by deleting files on the mass storage device to clear up space. It then converts the format of the mass storage device to New Technology File System (NTFS) if the computer on which the mass storage device is connected to has administrator privileges. If the computer does not have unlimited privileges, the invention will simply delete files it finds on the mass storage device without converting the format. The step 110 of converting is not absolutely essential, but desirable as it greatly facilitates other steps of the present method.

The method continues with step 113 by storing the appropriate encryption tool on the mass storage device by use of the computer. Step 113 includes, prior to storing the appropriate encryption tool on the mass storage device, that the installer makes sure to install the invention on a mass storage device. And, if the device is not a mass storage device, installation of the appropriate encryption tool fails. Step 113 also includes verifying, in an event that multiple mass storage devices are connected to a computer, which mass storage device the appropriate encryption tool should be installed onto. The appropriate encryption tool could be extracted from a disk, or downloaded from a server on the World Wide Web prior to its installing.

At step 114, the last installing step is to hide all the invention modules' folders onto the mass storage device. These folders are also converted into file system folders to better hide them. When the mass storage device is connected to a computer and a user opens a computer browser, only an executable shortcut appears to launch the security tool. Since the storage module is hidden, all encrypted user files are located in a hidden folder. The administrator module and the installing module of the method are thus completed and followed by configuring of the appropriate encryption tool.

The configuring begins with step 115 of opening the appropriate encryption tool through an operating system of the computer. Examples of the operating system include without being limited thereto Windows™, Linux™ Unix™, Mac™, etc.

The method continues the configuring with step 118 for filling the content of the mass storage device with insignificant data. This step increases the security level of mass storage device by preventing the user to copy any data directly on the mass storage device without first protecting it. Therefore, a user has to open the appropriate encryption tool to copy data on the mass storage device. The insignificant data may consist of a series or random information, or a series of bit of similar value, or any other combination, which fills the content of the mass storage device, and is unintelligible.

The configuring continues by verifying at step 120 if it is a first session, in the affirmative, the user will be led to step 122 by indicating an administrator public key received earlier from his IT administrator. It then pursues at step 124 with the entering of a configuring password.

The configuring continues at steps 125, 128 and 130 with generating a user public key from the configuring password. So as to increase the security of the mass storage device, the user public key is an asymmetric key. An asymmetric key generator, such as the Rivest, Shamir, and Adelman (RSA) public key generator is used to generate the user public-private key pair. Once created, this user public key is hashed with a hashing algorithm such as SHA-1, SHA-256 or MD5. The user public key hash digest is encrypted using the private key from the private-public key pair. The encrypted hash digest is saved at the end of the user public key file. The hashing function is used to ensure that the user public key file integrity has not been compromised.

The integrity verification is accomplished when the user public key is used to open the invention by comparing two hash digests. The first hash digest comes from the encrypted user public key hash digest (found at the end of the public key file) that is decrypted using the user public key. The second hash digest is obtained through hashing the user public key using the same hashing algorithm as the one used for the encrypted user public key digest. If the integrity of the user public key has not been compromised, the resulting hash digests will be identical. If these hash digests are not identical, the user public key has been altered.

The configuring part continues at step 128 with storing of the administrator and the user public keys on the mass storage device. Before storing these public keys, the required volume space is freed on the mass storage device. The freeing step may consist for example of deleting a part of the insignificant data equivalent in volume of the public keys to be stored. Afterwards, the public keys are stored on the mass storage device. After storing the public keys, the invention finally fills any free space left on the device with random values.

At step 130, the method proceeds with generating a secret key from random values. In an aspect of the present invention, the secret key is a symmetric key obtained through a generator of random number. The secret key is used to encrypt file selections, and once generated, it is separately protected by use of the user public key and by the use of administrator public key at step 132. Before storing both encryptions on the mass storage device, the required volume space is freed on the mass storage device. Afterwards, the encryptions are stored on the mass storage device at step 134. After storing the encryptions, the invention finally fills any free space left on the device with random values. The configuration part of the method is completed.

When the configuring part of the method is completed, the method pursues with steps of opening a session in order to securely store data on the mass storage device. If the opening of the session follows directly the configuration steps, the application will automatically be opened and will be ready to use without any user intervention as shown at step 149.

If the opening the session does not directly follow the configuration steps, the user will need to launch the application by either double clicking on the executable shortcut using his computer browser then, enter his opening password to open the tool at step 135. From the entered opening password, a user private key is generated using an asymmetric key generator at step 137. Once this private key is generated, step 139 further continues by using this user private key to decrypt the encrypted secret key as shown at step 132. If the secret key is successfully decrypted, the invention opens as per step 149. If the decryption of the secret key fails, one will need the administrator password to open the appropriate encryption tool.

The appropriate encryption tool can also be opened by entering the opening password step 103 combined to the administrator private key file at step 141. A secret key will be generated from the entered opening password at step 135. Step 143 indicates that this secret key is used to decrypt the encrypted administrator private key file originally found on the administrator computer using a symmetric decryption algorithm. If the decryption fails, the method does not open as per step 147. If the administrator private key is duly decrypted, step 145 continues with decrypting the encrypted secret key shown at step 132 using the administrator private key. If this last decryption fails, the method does not open as per step 147. If the decryption is successfully accomplished, the appropriate encryption tool opens as per step 149.

Once opened, the appropriate encryption tool continues with securely storing data on the mass storage device at step 149. At step 150, a file or files are selected by the user for encryption in the section representing the computer on which the mass storage device is connected to. The user then drags and drops his selection in the section of the appropriate encryption tool representing the mass storage device. Since the mass storage device has been filled with insignificant data, it is thus necessary to then first free space on the mass storage device, prior to storing new information thereon as per step 154. To ensure that only the required volume of space is freed on the mass storage device, the appropriate encryption tool continues at step 152 by estimating a data volume after encrypting. To efficiently estimate the data volume after encrypting, the required volume calculation is done by taking the data file size provided by the operating system and increasing it of 10%. To this result is added a minimum kilobyte size (4 Kb in FAT 32, 32 kb in FAT, 64 kb in NTFS) of the file system sector for each selected file.

Once the encrypted data volume has been estimated, the appropriate encryption tool continues at step 154 with freeing the estimated volume space on the mass storage device. The freeing step 154 may consist for example of deleting a part of the insignificant data equivalent in volume to the estimated volume of the information to be stored. Afterwards, the file selection is encrypted at step 156 with the decrypted secret key stored on the mass storage device using a symmetric algorithm. At step 157, the encrypted file selection is stored on the volume freed on the mass storage device. Once the encrypted file selection is stored on the mass storage device, the invention finally fills any free space left on the device with random values at step 159.

In order to use the method on the mass storage device at decryption, user makes his file selection in the section representing the mass storage device as per step 160. He then drags and drops it in the computer section of the appropriate encryption tool or directly out of the invention onto his desktop as per step 162. At step 165, once the selection is dropped, the secret key is used to decrypt it using a symmetric algorithm. The decrypted file selection is copied on the computer as per step 168 while the encrypted files remain secured on the mass storage device.

In step 170, in order to use the invention on the mass storage device to consult secured files directly located on the device, a user makes his file selection through the appropriate encryption tool for the mass storage device. He then double clicks on his selection to launch the decryption process in user temporary folders with the secret key using a symmetric algorithm (steps 172 and 174). Step 176 automatically executes the appropriate editing software to open the decrypted file selection. Once the editing software is closed as shown in step 178, before the file is automatically re-encrypted, the encryption volume is estimated.

Once the volume has been estimated as per step 180, the appropriate encryption tool continues at step 182 with freeing the estimated volume space on the mass storage device. Afterwards, the file selection is encrypted at step 184 using the decrypted secret key stored on the mass storage device. At step 186, the encrypted file selection is stored back on the volume freed on the mass storage device. Once the encrypted file selection is stored on the mass storage device, the appropriate encryption tool finally fills any free space left on the device with random values at step 188. Temporary files are filled with null characters before being deleted from host computer as shown in step 189.

In order to use the appropriate encryption tool to delete files on the mass storage device, step 190 indicates that the user needs to make the file selection he wants to delete. Once the selection is complete, the files are being deleted and freed space is filled back with random value as per step 196.

Reference is now made to Error! Reference source not found., which shows a block diagram of the exemplary appropriate encryption tool 200. The appropriate encryption tool 200 interacts with, amongst other things, a computer 201, a processing module 202 and a mass storage device 203. The appropriate encryption tool includes a symmetric encryption key generator 252, an asymmetric encryption key generator 250, an asymmetric encryption algorithm 255, a symmetric encryption algorithm 257, a signing module 258, a deleting module 270, a freeing and filling module 265, a storage module 260. The symmetric encryption key generator 252, the asymmetric encryption key generator 250, the asymmetric encryption algorithm 255, the symmetric encryption algorithm 257, the signing module 258, the deleting module 270, the freeing and filling module 265, the storage module 260 and finally the processing module 202 are modules of software installed on the mass storage device.

In an aspect of the present invention, it is the computer 201 that receives the administrator public encryption key 220, the configuring password 210, the encrypted administrator private key 227, the file selection 225 and the opening password 215.

The computer 201 forwards the administrator encryption public key 220, the encrypted administrator private key 227, the configuring password 210, the opening password 215, the file selection 225 to the processing module 202. The processing module 202 is adapted to determine what to do with inputs received from the computer 201. The mass storage device 203 is a hardware component that receives data from the storing module 260 and that also sends data for decryption to the processing module 202. The asymmetrical key generator 250 is conceived to receive a configuration password 210 or an opening password 215 to generate a private-public key pair 233 and 243. The symmetric key generator 252 generates an administrator secret key 231 from an opening password 215. The symmetric key generator 252 also generates a secret key 230 from random values. The asymmetric encryption algorithm 255 receives one key from the private-public key pair (220, 233, 236 and 243) to be used as encryption or decryption key. The asymmetric encryption algorithm 255 can also receive any data to be encrypted or decrypted (236, 246 and 247). The symmetric encryption algorithm 257 receives a secret key 230 or an administrator secret key 231 to be used as encryption or decryption key. The asymmetric encryption algorithm 257 can also receive any data to be encrypted or decrypted (225, 227 and 240).

The signing module 258 is adapted to receive any data and to make a digital fingerprint of such data to ensure its integrity. The storing module 260 and the freeing and filling module 265 are adapted to place the data on the mass storage device 203. The storing module 260 estimates the data volume needed to write on the mass storage device 203 and also writes on the mass storage device 203. The freeing and deleting module 265 frees volume on the mass storage device 203 and fills the mass storage device 203 after each operation. The deleting module 270 deletes data on the computer by replacing it with null characters.

The configuring password 210 is used to configure the appropriate encryption tool. The computer 201 sends the configuring password 210 to the processing module 202. The processing module 202 then sends this configuring password 210 to the asymmetric key generator 250 which returns a private-public key pair (233-243) back to the processing module 202. The user public key 243 is sent to the storing module 260 which using the freeing and filling module 265 stores the user public key 243 on the mass storage device 203. Before being stored, the user public key 243 integrity is protected by an appended digital signature using the signing module 258.

With the symmetrical key generator 252, a secret key 230 is generated from random values. This secret key 230 will later be used to encrypt and decrypt data on the mass storage device 203. The secret key 230 is encrypted using the asymmetric encryption algorithm 255 with the user public key 243. The asymmetric encryption algorithm 255 returns an encrypted user secret key 246 to be stored on the mass storage device 203 using the storing module 260 and the freeing and filling module 265. Before being stored, the encrypted user secret key 246 integrity is protected by an appended digital signature using the signing module 258. The private key 233 is discarded at this point.

The administrator public key 220 is used in conjunction with the configuring password 210 to configure the appropriate encryption tool. The computer 201 sends the administrator public key 220 to the processing module 202. The processing module 202 using the storing module 260 and the freeing and filling module 265 will store the administrator public key 220 on the mass storage device 203. The secret key 230 is encrypted using the asymmetric encryption algorithm 255 with the administrator public key 220. Before using the administrator public key 220, the administrator public key 220 integrity is verified by the signing module 258. The asymmetric encryption algorithm 255 returns an encrypted administrator secret key 247 on the mass storage device 203 using the storing module 260 and the freeing and filling module 265. Before being stored, the encrypted administrator secret key 247 integrity is protected by an appended digital signature using the signing module 258.

To open the appropriate encryption tool using the opening password 215, the computer 201 sends to the processing module 202 an opening password 215. This opening password 215 is then sent to the asymmetric key generator 250 to generate a private-public key pair (233 and 243). At this point the public key 243 is discarded. The encrypted user secret key 246 found on the mass storage device 203 is decrypted using the asymmetrical encryption algorithm 255. Before decryption, the encrypted user secret key 246 integrity is verified by the signing module 258. The decrypted secret key 230 is used to encrypt and decrypt file selection 225.

When an opening password 215 fails to decrypt the user secret key 246 as described above, the appropriate encryption tool will alternately try to open using the encrypted administrator private key 227. The computer 201 sends the password 215 to the processing module 202. The processing module sends the password 215 to the symmetric key generator 252 to generate an administrator secret key 231. This secret key 231 is used to decrypt the encrypted administrator private key 227 received from the computer 201 with a symmetrical encryption algorithm 257. Before decryption, the encrypted administrator private key 227 integrity is verified by the signing module 258. The processing module 202 takes the encrypted administrator secret key 247 located on the mass storage device 203 and decrypts it with the administrator private key 236 using an asymmetrical encryption algorithm. Before decryption, the encrypted administrator secret key 247 integrity is verified by the signing module 258. The resulting secret key 230 is then used to encrypt and decrypt file selection 225.

The file selection 225 is sent to the processing module 202 by the computer 201. With the secret key 230, the file selection 225 is encrypted using a symmetric encryption algorithm 257. At encryption, the encrypted file selection 240 integrity is protected using the signing module 258 by appending a digital signature. The encrypted file selection 240 is sent to the storing module 260 and the freeing and filling module 265. The storing module 260 and the freeing and filling module 265 then save the encrypted file selection 240 on the mass storage device 203.

The encrypted file selection 240 is sent to the processing module 202 by the mass storage device 203. With the secret key 230, the encrypted file selection 240 is decrypted using a symmetric encryption algorithm 257. Before decryption, the encrypted file selection 240 integrity is verified by the signing module 258. The decrypted file selection 225 is sent to the computer 201.

To execute a decryption directly from the appropriate encryption tool, an encrypted file selection 240 is sent to the processing module 202 by the mass storage device 203. The secret key 230 is used to decrypt the encrypted file selection 240 using the symmetric encryption algorithm 257. Before decrypting any encrypted file selection 240, the encrypted file selection 240 integrity is verified by the signing module 258. The symmetric encryption algorithm sends the decrypted file selection 225 and the processing module 202 sends it back on the computer 201 in a user temporary folder. The processing module 202 launches the file selection 225 editing application. Once the editing application is closed, the processing module 202 automatically re-encrypts the file selection 225 with the secret key 230 using the symmetric key encryption algorithm 257. The encrypted file selection 240 is sent to the storing module 260 as well as the freeing and filling module 265 to be placed back on the mass storage module 203. Before sending the encrypted file selection 240, the encrypted file selection 240 integrity is protected by an appended digital signature using the signing module 258. Once this is completed, the deleting module 270 fills the file selection 225 in the user temporary folder on the computer 201 with null characters before deleting it.

To delete an encrypted file selection 240, the processing module 202 deletes the encrypted file selection 240 from the mass storage device 203. The processing module then communicates with the freeing and filling module 265 to fill any free space found on the mass storage device 202 with insignificant data.

It should be clear to those skilled in the art that although the appropriate encryption tool has been described by means of example herein, multiple rearrangements and modifications thereto could be performed without departing from the scope of the present invention. Such description is used for exemplary purposes only, so as to explain possible relations and interactions between the method and surveillance tool of the present invention with the appropriate encryption tool.

Reference is now made to Error! Reference source not found., which shows a flowchart of a method for managing security of a mass storage device in accordance with an aspect of the present invention.

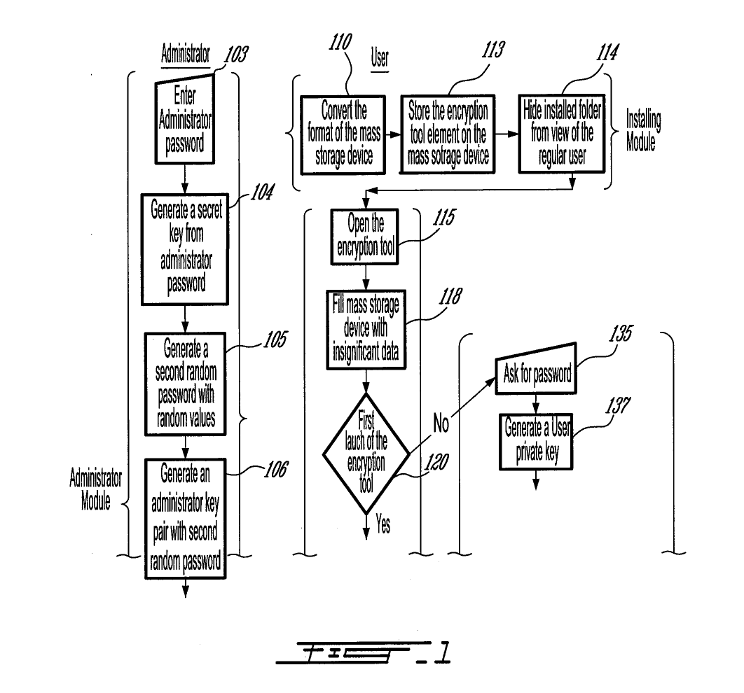

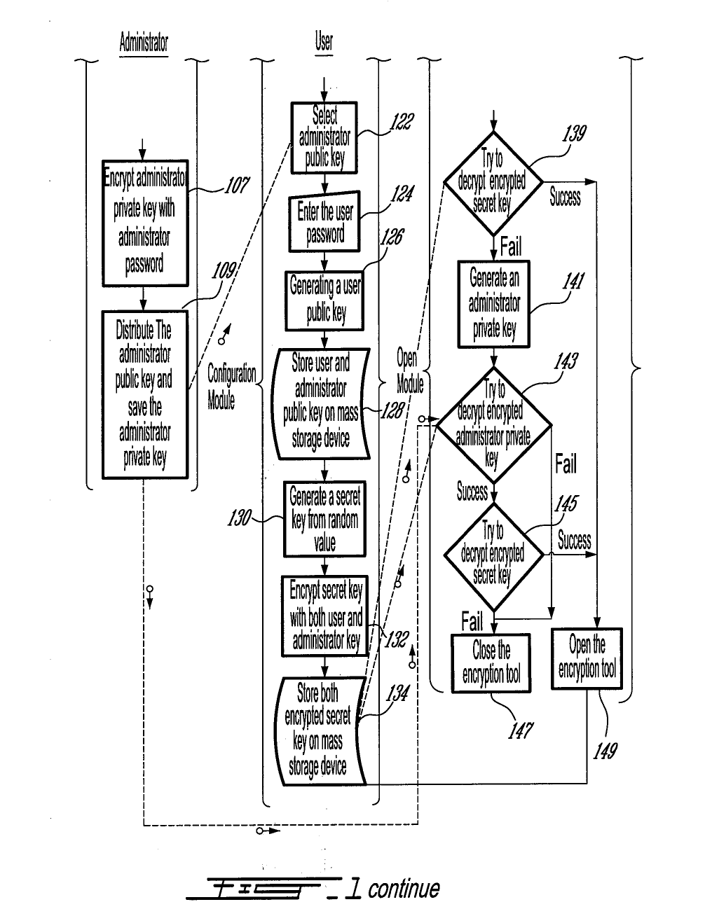

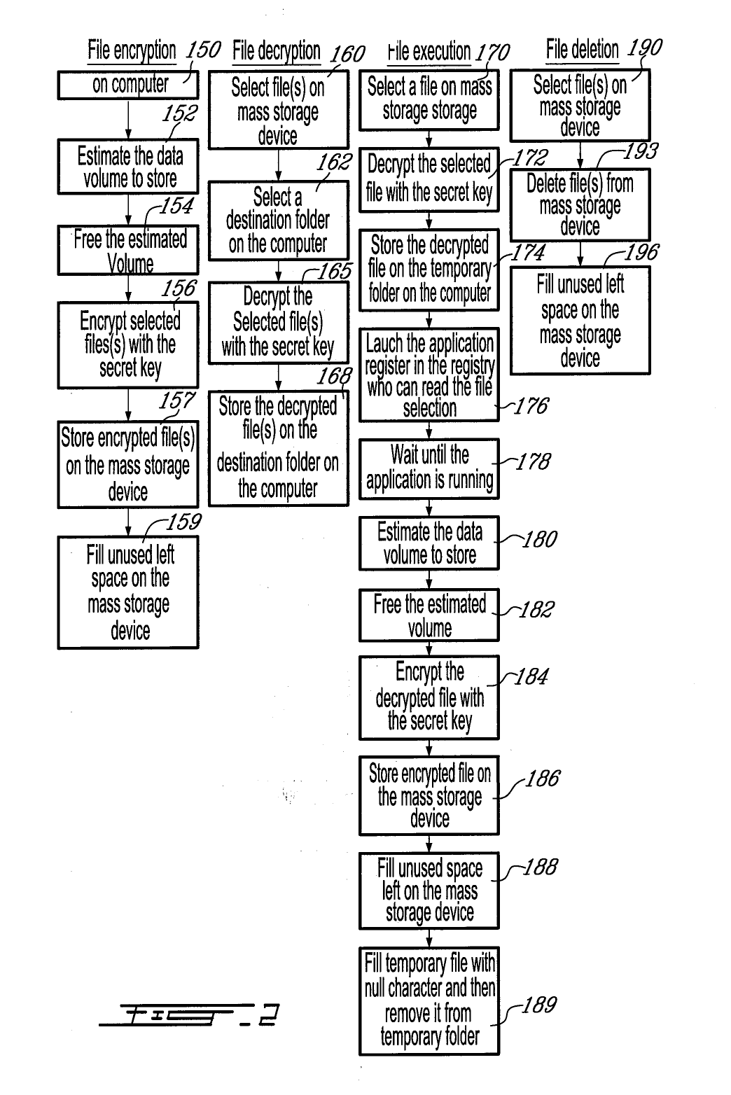

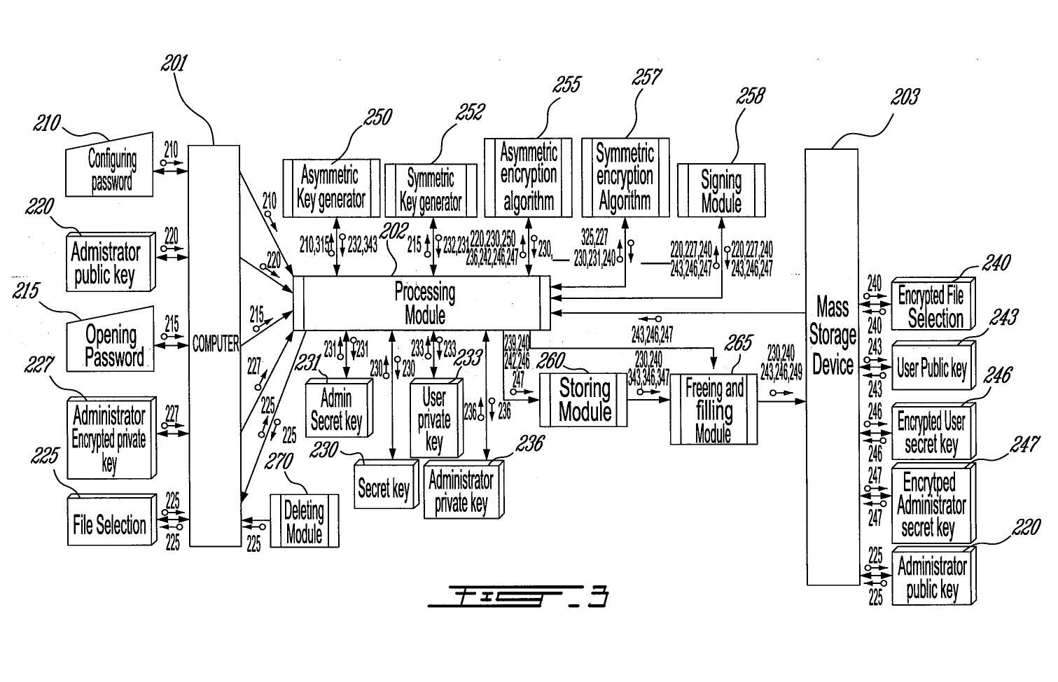

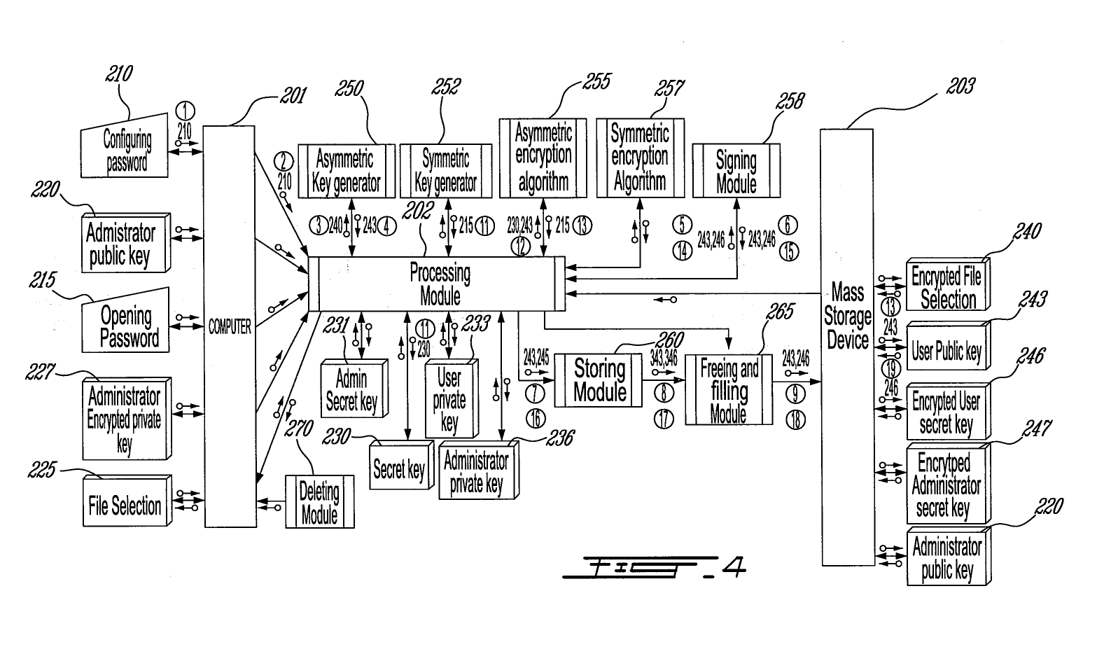

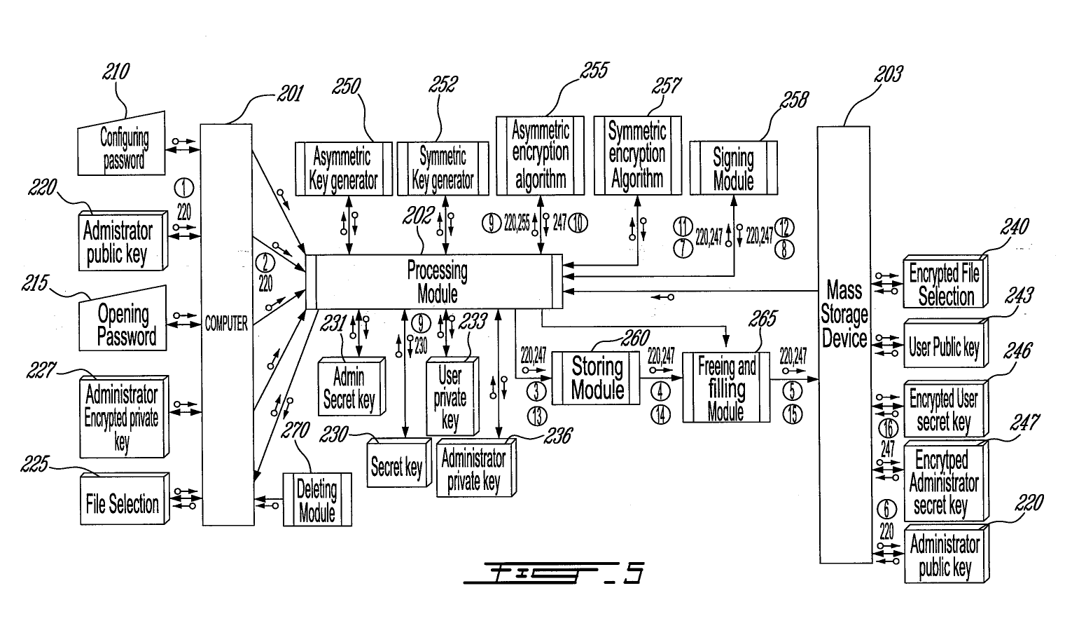

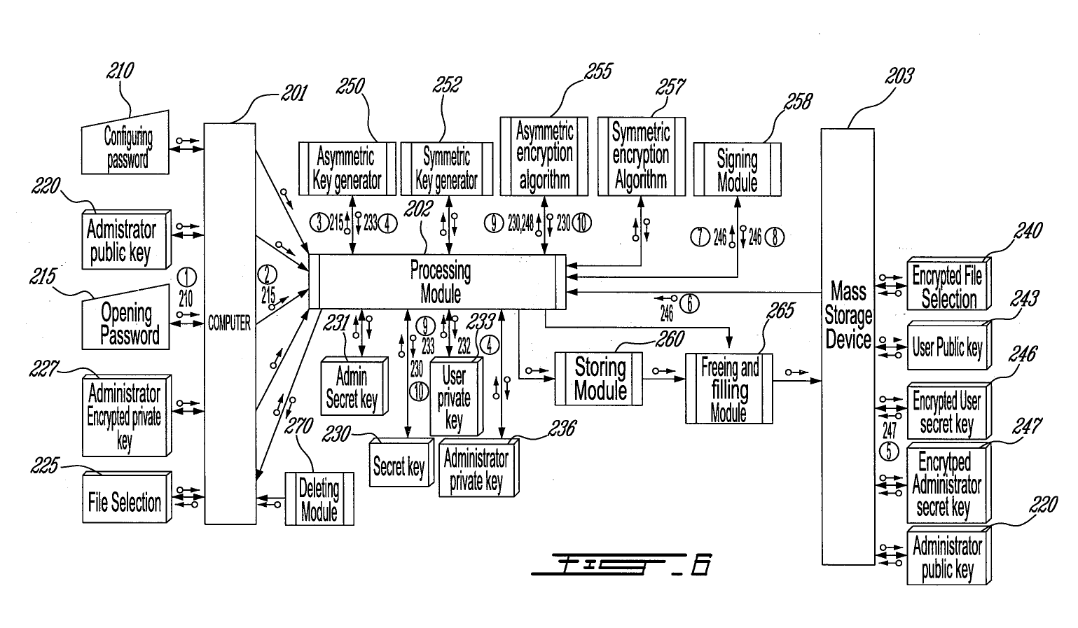

The method starts by installing 310 a surveillance tool on a computer from which the mass storage device is to be accessed. Such installing has been previously described in the administrator module and installing module and depicted in FIG. 1. Verification is afterwards done of whether there is a mass storage device connected, step 320, to the computer. When there is one mass storage device connected, the method pursues with a step of determining whether the mass storage device is secured with the appropriate encryption tool, step 330. In the event that the mass storage device is not secured, the method pursues with blocking the mass storage device at step 350.

Once the surveillance tool determines that the mass storage device is unsecured, the surveillance tool may have been prior configured to install the appropriate encryption tool on. To the exception that at installing at step 110 the converting of the format of the mass storage device to New Technology File System (NTFS) will be achieved on any computer with or without administrator privileges.

The formatting in NTFS of a mass storage device is accomplished because the surveillance tool runs at the same time both in system mode and in local user mode. This permits local operation on a computer such as automatically opening of the appropriate encryption tool as well as some system operations such as NTFS converting.

More particularly, in step 330, the method could further consist of verifying whether the mass storage device is secured with a preferred appropriate encryption tool. A preferred appropriate encryption tool could for example consist of a particular appropriate encryption tool, with a predetermined version, and customized to recognize mass storage devices belonging to a particular owner/company. If such preferred appropriate encryption tool is found on the mass storage device, the surveillance tool will launch the appropriate encryption tool and install an icon representing the tool on the user's desktop. As long as the protected mass storage device remains connected to the computer on which the surveillance tool is installed on, the user will be able to open the appropriate encryption tool 340 on his mass storage device simply by clicking on the corresponding icon from his desktop. If this icon is deleted from the user desktop, the surveillance tool will replace it back without any user intervention. This icon will automatically disappear if the mass storage device is disconnected. Such a level of verification could thus ensure that the mass storage devices used on computers of a particular company are the mass storage devices of the company, with the proper level of security thereon.

The method may further include the possibility of allowing reading of mass storage devices not protected by the preferred appropriate encryption tool, while blocking any writing thereto.

The method and surveillance tool of the present invention may advantageously be implemented by means of software. The surveillance tool may further function transparently in background of the computer, without user intervention. The surveillance tool may further be equipped with a module allowing automatic updating of the preferred appropriate encryption tool on the mass storage devices connected on the computer. For ease of use, the surveillance tool may function in either a user mode, with limited privileges, or in an administrator mode, with unlimited privileges. Additionally, the surveillance tool may further include a logging module, which logs names of all files protected on each mass storage device, so as to keep records in case of loss of a protected mass storage device.

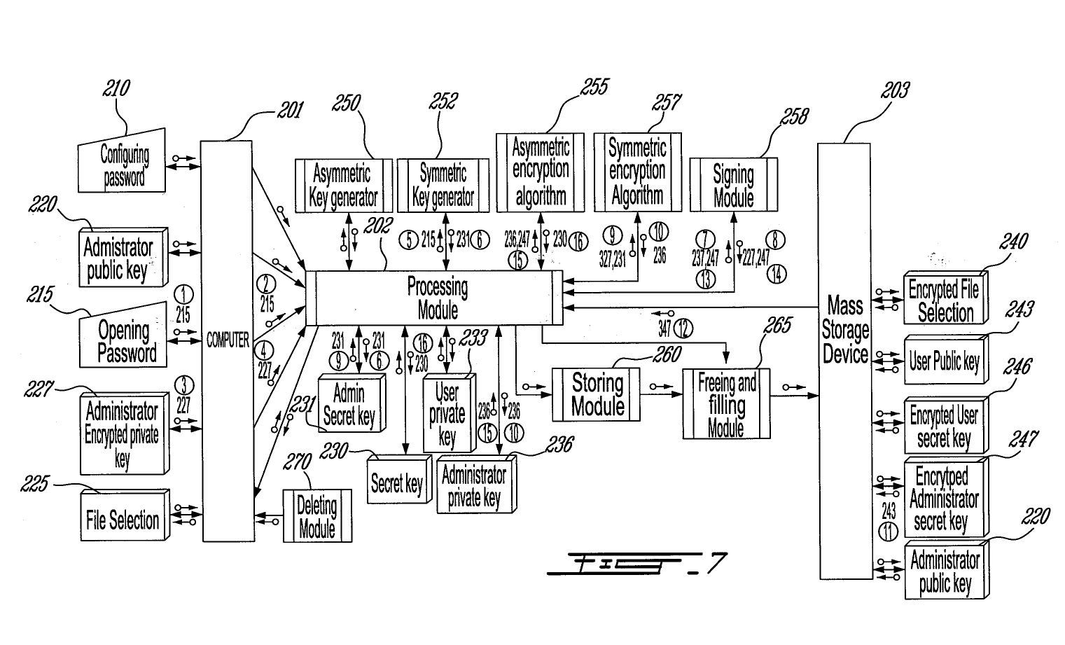

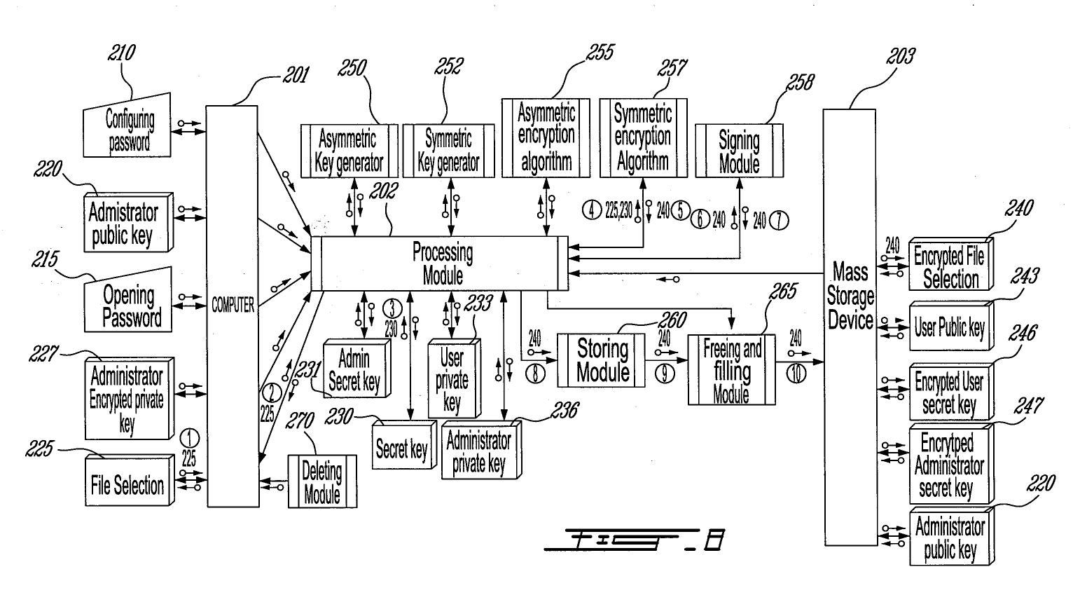

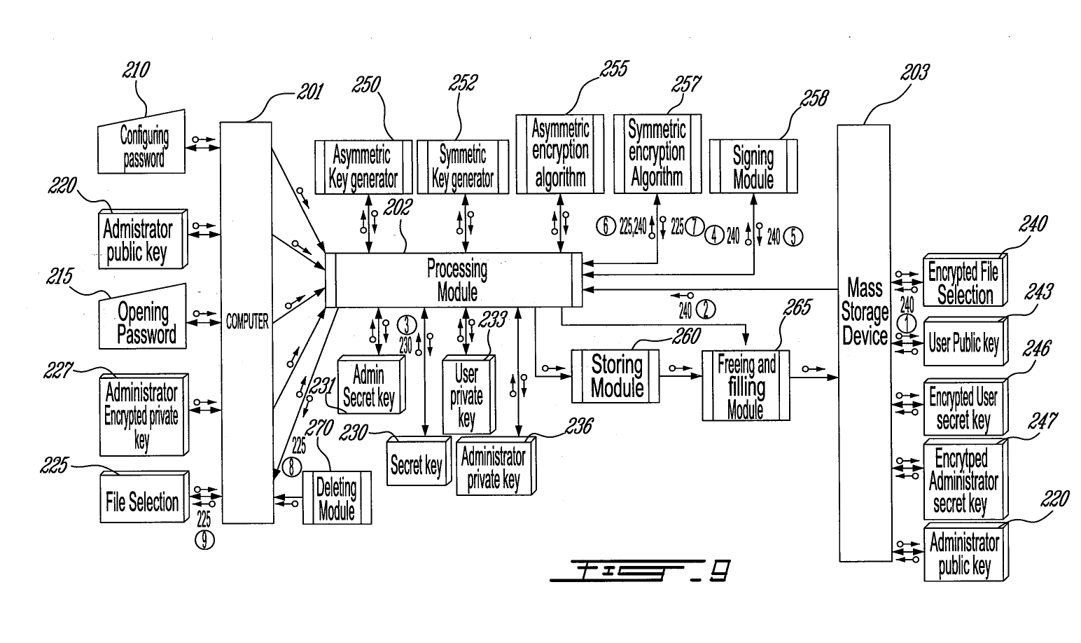

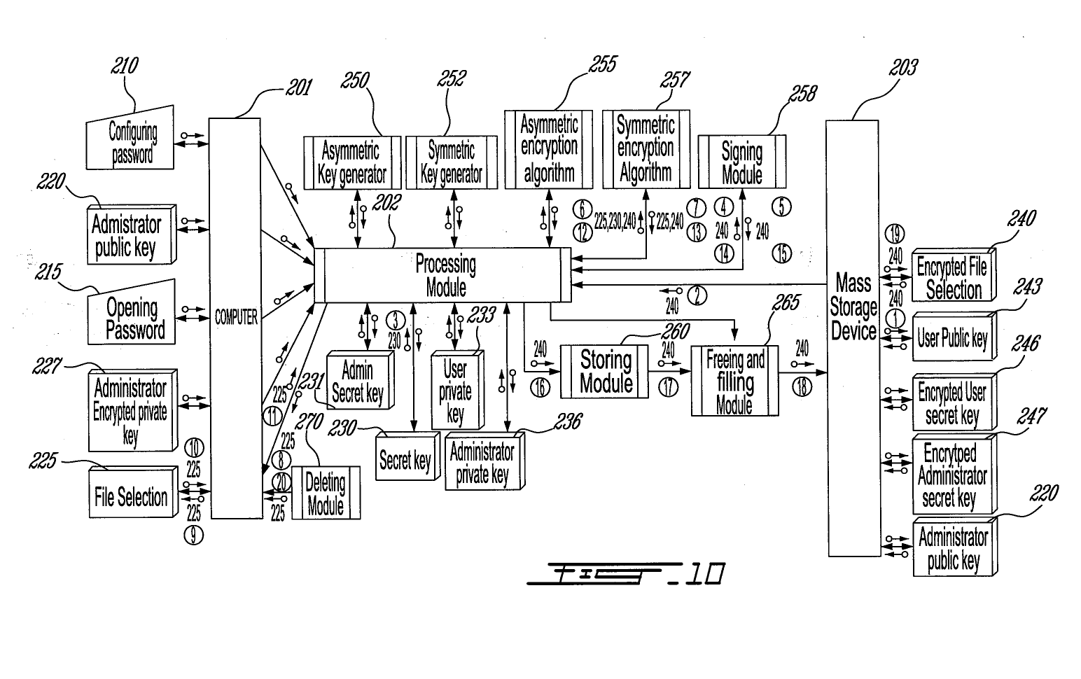

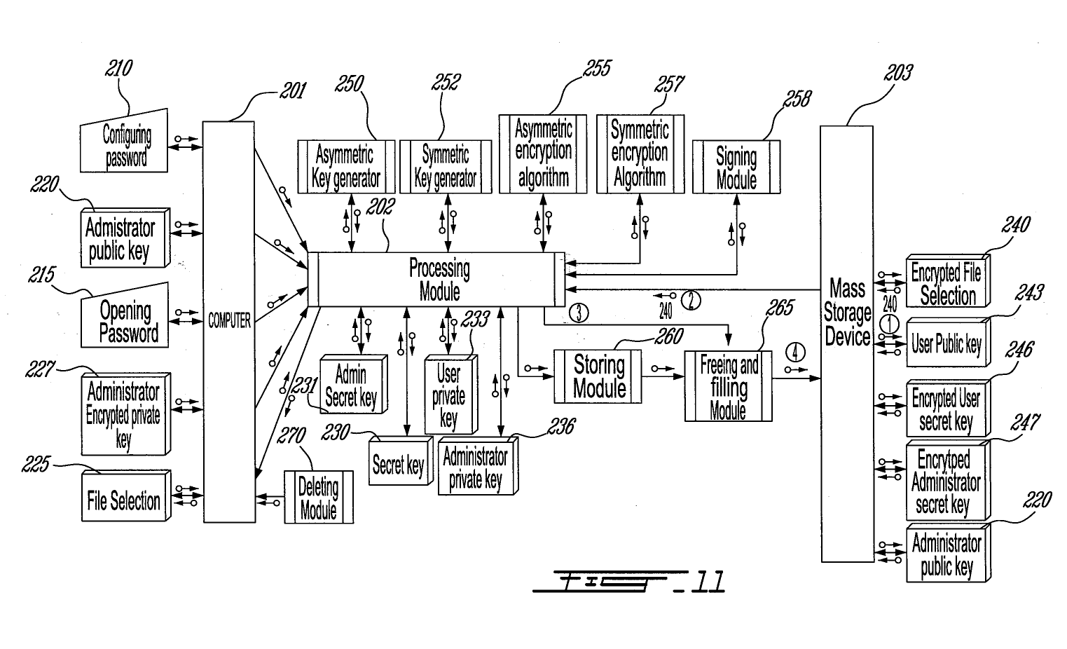

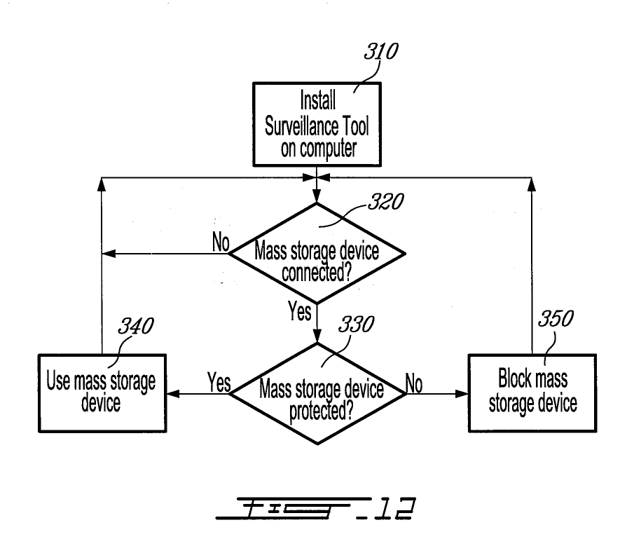

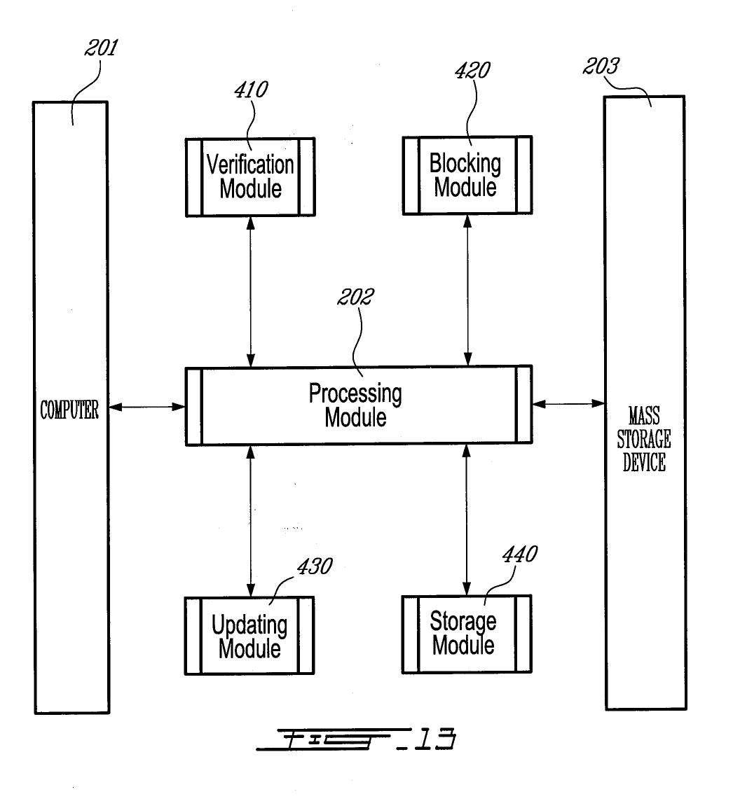

Referring now to FIG. 13, there is shown a block diagram of an exemplary surveillance tool in accordance with an aspect of the present invention. The surveillance tool includes a verification module, and a blocking module. The verifying module verifies whether the mass storage device is connected, and determines whether the appropriate encryption tool is present on the mass storage device. Then, when the mass storage is connected and the appropriate encryption tool is not present, the blocking module blocks access to the mass storage device. The blocking module may block complete access to the mass storage device, or alternatively, allow read only access to the mass storage device.

The surveillance tool may further include an updating module for verifying whether a version of the appropriate encryption tool is current, and if not, automatically updating the appropriate encryption tool on the mass storage device to a current version. The surveillance tool may also include a storage module for storing identification of files stored on the mass storage device.

Additionally, the surveillance tool may further include a secret key generator, a random value generator, an administrator key pair generator and an encoder. The secret key generator is adapted to receive a password from an administrator and generate there from a secret key. The random value generator generates a random password with random value. The administrator key pair generator generates with the random password and the secret key an administrator key pair, while the encoder encodes the administrator key pair with the administrator password.

The surveillance tool and method of the present invention may be, in a preferred embodiment of the present invention, implemented as software.

The present invention has been described by way of preferred embodiment. It should be clear to those skilled in the art that the described preferred embodiments are for exemplary purposes only, and should not be interpreted to limit the scope of the present invention. The method and surveillance tool as described in the description of preferred embodiments can be modified without departing from the scope of the present invention. The scope of the present invention should be defined by reference to the appended claims, which clearly delimit the protection sought.

1. A method of managing security of mass storage devices, the method comprising steps of:
installing a surveillance tool on a computer;
verifying by the surveillance tool whether there is a mass storage device connected to the computer;
determining by the surveillance tool whether the mass storage device is secured with an appropriate encryption tool, if the mass storage device is not secured with the appropriate encryption tool, preventing use of the mass storage device on the computer.

2. The method of managing security of mass storage devices of claim 1, wherein the preventing use of the mass storage device prevents writing to the mass storage device while allowing reading from the mass storage device.

3. The method of managing security of mass storage devices of claim 1, wherein the method further includes a step of:
automatically updating the appropriate encryption tool upon availability of a new release.

4. The method of managing security of mass storage devices of claim 1, further comprising a step of:
detecting whether the mass storage device is connected to an unprotected computer; and
reporting detected connection to unprotected computer upon connection to the computer.

5. A surveillance tool for securing a mass storage device, the surveillance tool comprising:
a verification module for verifying whether the mass storage device is connected, and for determining whether an appropriate encryption tool is present on the mass storage device; and
a blocking module for blocking access to the mass storage device when the verification module determines that the appropriate encryption tool is not present on the mass storage device.

6. The surveillance tool of claim 5, further comprising:
an updating module for verifying whether a version of the appropriate encryption tool is current, and if not, automatically updating the appropriate encryption tool on the mass storage device to a current version.

7. The surveillance tool of claim 5, further comprising:
a storage module for storing identification of files stored on the mass storage device.

8. The surveillance tool of claim 5, wherein the blocking module blocks writing access to the mass storage device when the verification module determines that the appropriate encryption tool is not present on the mass storage device.

9. The surveillance tool of claim 5, wherein the surveillance tool is implemented as software.
